(19) United States
(12) Patent Application Publication
(10) Pub. No.: US 2006/0170931 A1
(43) Pub. Date: Aug. 3, 2006

(54) Biochemical sensors with micro-resonators

(75) Inventors: Lingjie Jay Guo, Ann Arbor, MI (US); Chung-Yen Chao, Ann Arbor, MI (US)

Correspondence Address: HARNESS, DICKEY & PIERCE, P.L.C., P.O. BOX 828, BLOOMFIELD HILLS, MI, 48303, US

(73) Assignee: The Regents of the University of Michigan, Ann Arbor, MI (US)

(21) Appl. No.: 11/352,623

(22) Filed: Feb. 13, 2006

Related U.S. Application Data
(63) Continuation-in-part of application No. PCT/US04/25942, filed on Aug. 11, 2004.
(60) Provisional application No. 60/494,825, filed on Aug. 13, 2003.

(51) Int. Cl. G01B 9/02

(52) U.S. Cl. 356/480

(57) ABSTRACT

A biochemical sensor. The biochemical sensor includes a microcavity resonator including a sensing element defining a closed loop waveguide. The biochemical sensor is operable to detect a measurand by measuring a resonance shift in the microcavity resonator.

### CROSS-REFERENCE TO RELATED APPLICATIONS

This application is a continuation-in-part of PCT/US2004/025942, filed Aug. 11, 2004, which claims the benefit of U.S. Ser. No. 60/494,825, filed Aug. 13, 2003. The disclosures of the above applications are incorporated herein by reference.

### FIELD OF THE INVENTION

The present invention relates to sensors and, more particularly, relates to chemical and biochemical sensors.

### INTRODUCTION

There are various known optical devices for chemical and biological sensor applications. Some optical sensors are based on optical fiber or optical waveguides and use evanescent wave to sample the presence of analytes in the surrounding environment or adsorbed on waveguide surfaces. Detection can be made by optical absorption spectrum of the analytes, optic evanescent wave spectroscopy, or by effective refractive index change. While the former two mechanisms can be directly obtained by optical intensity measurement, the accurate measurement of the effective refractive index change of the guided mode of a waveguide requires certain configurations to transduce the index change to detectable signals. The latter category involves such sensors as surface plasmon resonance sensors, Mach-Zehnder Interferometer (MZI) devices, and optical grating couplers. These sensors are not sensitive enough to detect molecules present in low concentrations using current technologies.

Optical waveguide sensors using evanescent wave to interrogate the presence of analytes on waveguide surface or in surrounding environment typically rely on the detection of effective refractive index change. In order to detect very low concentration or minute amount of analytes using optical waveguide sensors, long waveguide length (exceeding cm) are typically required in order to accumulate a detectable phase shift. Significant numbers or amount of samples that may not be readily obtainable in many applications are also required.

Known sensors based on optical resonators include microsphere cavities using Whispering Gallery Mode (WGM) resonances, which can respond to a monolayer of protein absorption, and integrated microdisk resonators based on optical scattering, absorption, or fluorescence. Microsphere-based biochemical sensors have limited ability to form large arrays. Known sensor devices using microdisks have been limited in their manufacture to inorganic materials such as silica and nitride oxides and have bulky detection systems.

Although the prior art sensors can be satisfactory for their intended purposes, improved biochemical sensors are still desirable.

### SUMMARY OF THE INVENTION

The present teachings provide a biochemical sensor that includes a microcavity resonator including a sensing element defining a closed loop waveguide. The biochemical sensor is operable to detect a measurand by measuring a resonance shift in the microcavity resonator.

The present teachings also provide a biochemical sensor that includes a microcavity resonator having an asymmetric resonance line shape, wherein the biochemical sensor is operable to detect a measurand by measuring a resonance wavelength shift in the microcavity resonator.

The present teachings also provide an inteferometric biochemical sensor that includes an open arm, and a ring feedback arm coupled to the open arm. The biochemical sensor is operable to amplify a phase shift between the open arm and a corresponding portion of the ring feedback arm in the presence of a measurand.

Further areas of applicability of the present invention will become apparent from the detailed description provided hereinafter. It should be understood that the detailed description and specific examples are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1A is a schematic of a biochemical sensor according to the present teachings, and showing a microring resonator according to the present teachings;

FIG. 1B is a diagram indicating a representative spectrum shift for the biochemical sensor of FIG. 1A;

FIG. 1C is a schematic of a biochemical sensor according to the present teachings; and showing a microring waveguide between two bus waveguides according to the present teachings;

FIGS. 1D and 1E are diagrams indicating representative specta for the biochemical sensor of FIG. 1C;

FIG. 2A is a schematic of a biochemical sensor according to the present teachings, and showing two partially reflecting elements in a bus waveguide;

FIG. 2B illustrates representative transmission spectra for the biochemical sensor of FIG. 2A in solid line and for the biochemical sensor of FIG. 1A in dotted line;

FIG. 3A is a micrograph of a polystyrene microring with waveguide offsets for a biochemical sensor according to the present teachings;

FIG. 3B is a diagram showing the measured transmission spectrum for the biochemical sensor of FIG. 3A;

FIG. 4A is a diagram illustrating the transmission spectra of the biochemical sensor of FIG. 3A immersed in different glucose solutions;

FIG. 4B is a diagram illustrating glucose concentration as a function of resonant wavelength shift for the biochemical sensor of FIG. 3A;

FIG. 5A is a schematic of biochemical sensor according to the present teachings, showing a vertically coupled microdisk resonator;

FIG. 5B is a schematic of biochemical sensor according to the present teachings, showing a vertically coupled microring resonator;

FIG. 6 is a diagram showing the transmission coefficient as a function of the gain/absorption factor for biochemical sensor according to the present teachings;

FIG. 7A is a schematic of a ring-feedback inteferometric biochemical sensor according to the present teachings;

FIG. 7B is a diagram comparing the transmission spectra of the biochemical sensor of FIG. 7A with a conventional MZI sensor;

FIG. 7C is a diagram comparing the slope sensitivity of the biochemical sensor of FIG. 7A with a conventional MZI sensor; and

FIG. 8 is a graph illustrating an evolution of the resonant wavelength shift throughout three demonstration steps.

### DETAILED DESCRIPTION

The following description of various embodiments is merely exemplary in nature and is in no way intended to limit the invention, its application, or uses. For example, although the present teachings are illustrated using microring resonators, the present teachings are also applicable to other microcavity resonators, such as microdisk and microsphere resonators.

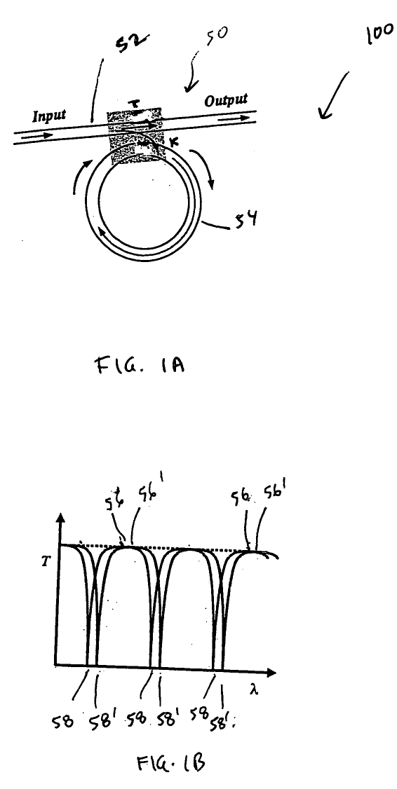

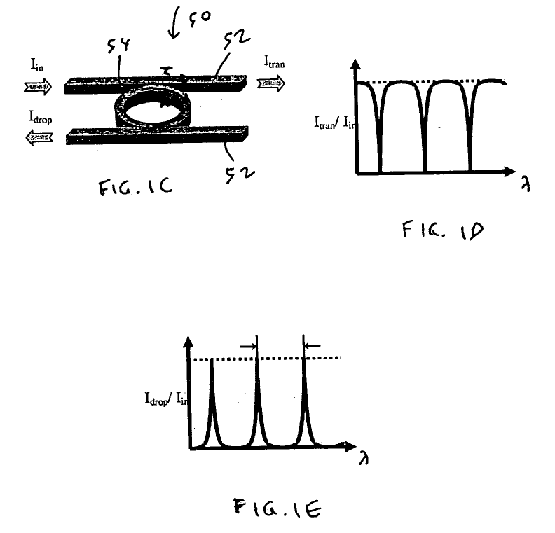

Referring to FIG. 1A, an exemplary biochemical sensor 100 according to the present teachings includes a microcavity resonator 50. The microcavity resonator 50 includes a sensing element in the form of a closed loop waveguide 54, such as a microring waveguide. The microcavity resonator 50 also includes a substantially straight bus waveguide 52, which serves as an input/output. In FIG. 1A, T is the transmission coefficient of the bus waveguide 52, and κ is the coupling coefficient. Although a circular ring is illustrated for the ring waveguide 54, any annular ring or other closed loop shape can be used. Light is incident from an input port on the left of the bus waveguide 52. Additionally, two bus waveguides 52 can be used with the microring waveguide 54 therebetween, as illustrated in FIG. 1C, with corresponding spectra illustrated in FIGS. 1D and 1E.

When the wavelength of the input light is varied, and when the circumference of the microring waveguide 54 is equal to multiple integers of the wavelength in the bus waveguide 52, the input light can be resonantly coupled into the microring waveguide 54. Referring to FIG. 1B, a series of periodic peaks 56 and dips 58 in the graph of transmission T as a function of wavelength λ A can be observed. If the effective refractive index of the microring waveguide 54 is changed, the resonance peaks and dips shift accordingly, as shown in FIG. 1B. The refractive index change is caused by the measurand, i.e. either the presence of biomolecules attached on the surface of sensing areas, or by the refractive index change of a solution surrounding the microcavity resonator 50. Detections are made by measuring the resonance shifts, from peaks 56 to peaks 56′ and from dips 58 to dips 58′, as shown in FIG. 1B. Alternatively, detection can also be made by the measurement of the output intensity change from the microresonator 50 at a fixed wavelength. The latter detection method is especially useful for detecting very small concentration of analytes. Effective refractive index resolution down to a level of 10⁻⁹ can be feasible by using high-Quality (“Q”) microresonators.

An alternative sensing scheme can be achieved based on enhanced optical absorption or fluorescence. In microring or microdisk resonator structures, the optical fields are confined in the optical waveguides and their intensity increases by the resonant effect, which can enhance the fluorescence signal in the traditional fluorescent-labeled detection. The sensitivity for detecting the presence of absorbing species can also be increased with respect to direct detection by an energy build-up factor of the resonator, which in practice can probably be as large as 10⁴. The microcavity resonator structure can be conveniently constructed to have its resonant wavelength match the maximum absorption wavelength of different analytes. Thus, an array of integrated microcavity resonator devices with different resonance frequencies can be constructed to detect multiple analytes simultaneously on the same chip. On the other hand, if the chemical species have negligible absorption in the wavelength of interest, the refractive index change of the material due to the loading of the analytes can be used.

According to the present teachings, the microcavity resonator 50 can be made of various materials, including organic materials, composites that include organic materials and inorganic materials, and combinations thereof, by a known direct imprinting technique, which is described in “Polymer Micro-ring Resonators Fabricated by Nanoimprint Technique”, C. Y. Chao and L. J. Guo, Journal of Vacuum Science and Technology, B 20(6), pp. 2862-2866, 2002. The resonator 50 can also be made of an inorganic material that is coated with an organic coating. The organic material can include, for example, a polymer. The use of polymer material offers a number of advantages. Polymers provide rich surface chemical functionalities for binding biomolecules such as proteins. For example, polymers such as polystyrene (PS), polymethylmethacrylate (PMMA) and polyethylene terephthalate (PET) can be modified to introduce COOH groups on their surface, which can be subsequently reacted with amine-terminated biotin. A streptavidin-biotin interaction can be used to subsequently bind any biotinylated protein molecules or antibodies onto the polymer surface. Arrays of sensors can be built, for example, by attaching different types of antibodies onto different microcavity resonators. Additionally, the surface of at least a portion of the resonator 50 can be provided with one or more receptors for binding with biomolecules to permit surface sensing. Further, the surface roughness of polymer microcavity resonators 50 can be significantly reduced by a thermal re-flow process, which provides greatly enhanced Q-factor in the resonance spectrum. Polymer waveguides allow efficient coupling to optical fibers because of the comparable refractive indices between polymer and glass, which greatly facilitate the sensor's integration and characterization.

Briefly, in direct imprinting, a silicon mold with microcavity paterns, such as microring or micro-racetrack patterns, is first fabricated by a combination of electron-beam lithography, nanoimprinting, and reactive ion etching (RIE). A thin polymer film, such as polystyrene (PS) film, is spin-coated on an oxidized silicon substrate. Then the mold is imprinted into the PS film under a pressure of 900 psi and temperature of 175° C. After cool-down and separation of the mold from the substrate, PS waveguides with microcavity resonators are formed. Any residual PS layer can be subsequently removed by RIE, and the oxide underneath the PS waveguide is isotropically wet-etched. The latter step is taken to create a pedestal structure beneath the waveguide, which enhances light confinement within the waveguide and increases the surface area of the device that can interact with analytes.

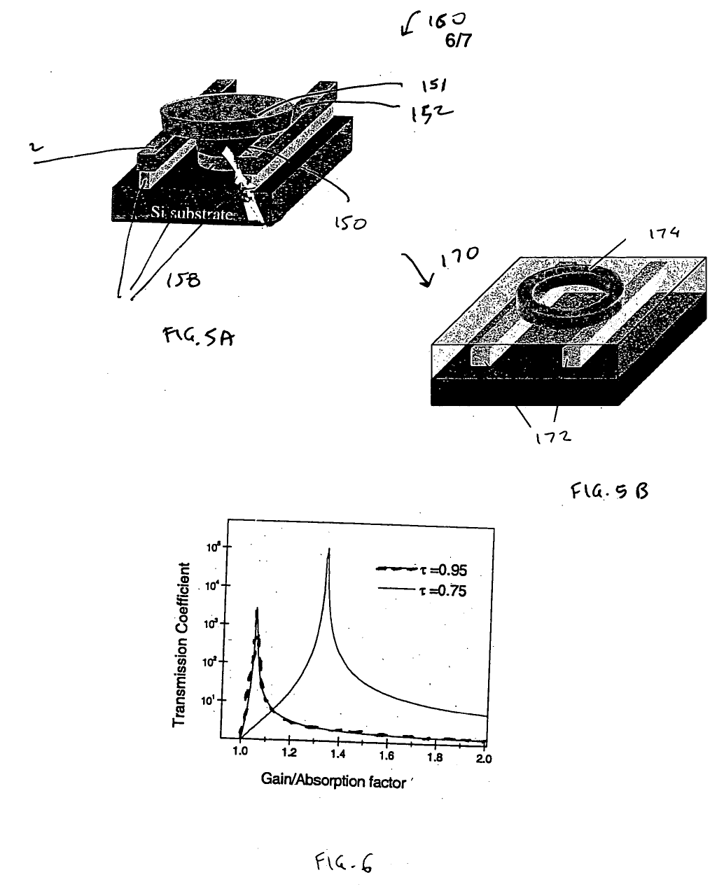

A core bus waveguide 52 and a microring waveguide 54 can be used with a fluid cladding, such as air, water or organic solvent. Such a structure gives the maximum accessibility for the evanescent wave to sample the solutions around the microring waveguide 54 and the biomolecules attached to waveguide surface. It is also desirable to have single-mode propagation in the microring waveguide 54 and the bus waveguide 52. This structure achieves a large free spectral range (FSR), which is advantageous for arrayed sensors to easily distinguish the spectra corresponding to different microresonators. By taking into account the operation resonance wavelength, the dimensions of the bus waveguide 52 and the microring waveguide 54 can be determined. The coupling coefficient between the bus waveguide 52 and the microring waveguide 54 plays an important role in determining the resonator characteristics, and depends exponentially on the gap distance between the ring waveguide 54 and the bus waveguide 52. In order to provide sufficient coupling, the gap width at the coupling region can be in the range of few hundreds of nm. Accordingly, a polymer structure with aspect ratio of ˜10:1 may be used for such resonators 50. These stringent dimensions can be achieved by the direct imprinting technique described above, or alternatively by vertically-coupled structure described below in reference to FIG. 5B.

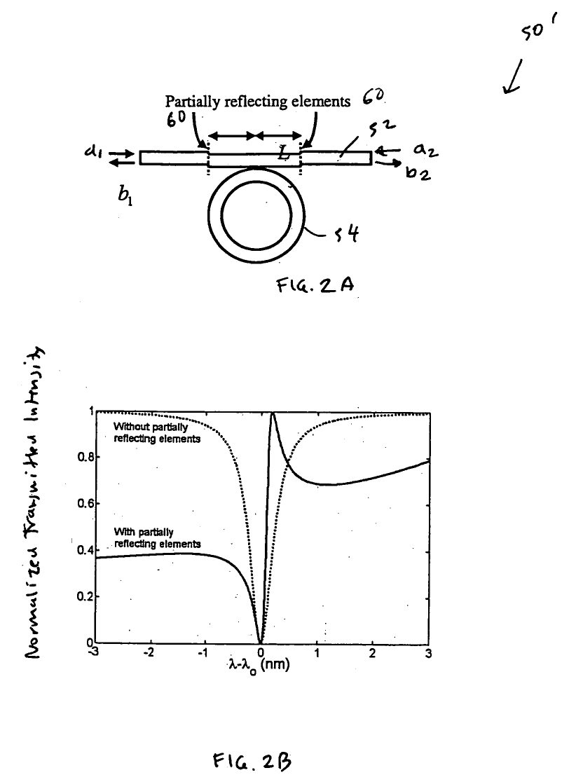

The resonance line-shape of the micro-ring resonator 50 is symmetrical with respect to its resonant wavelengths, as shown in FIG. 1B. In another aspect of the present teachings, a new microring resonator 50′ can be used with the biochemical sensor 100, as shown in FIG. 2A. The microring resonator 50′ can produce an asymmetrical Fano-resonant line shape, in which the slope between the zero and unit transmissions is greatly enhanced. The sharply asymmetric line-shape of the Fano-resonance can provide higher slope sensitivity than conventional microring structures made with the same Q-factor. The asymmetrical feature can be obtained by incorporating two partially reflecting elements 60 into the bus waveguide 52 that is coupled to the microring waveguide 54, as shown in FIG. 2A. An example of the asymmetric resonance is shown in FIG. 2B (solid line).

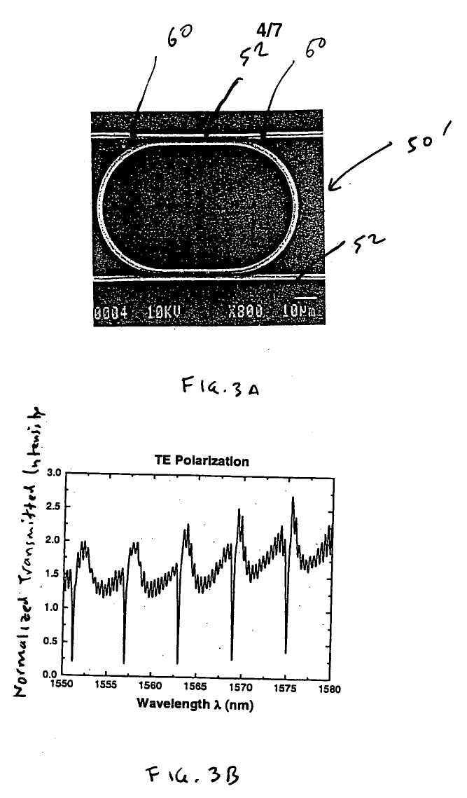

Referring to FIG. 3A, a microring waveguide 54 is positioned between two bus waveguides 52, At least one of the bus waveguides 52 includes reflecting elements 60 that can be achieved by waveguide offsets. The waveguide offsets 60 introduce backward propagating waves that can perturb the phase of the transmitted wave and hence lead to complex interference and Fano-resonance line shape. The magnitude of the offset controls the reflection and affects the line shape of the transmission spectrum. FIG. 3A shows a scanning electron micrograph (SEM) of a microring resonator 50′ fabricated from polystyrene (PS) using the direct imprinting technique. As known in the art, the transmission spectrum can be measured with a tunable laser, such as the model Santec TSL-220 laser. The polarization of the incident laser beam is controlled by a half-wave plate and a polarizer. The laser beam is coupled into PS waveguides and collected by objective lenses. FIG. 3B shows the corresponding measured transmission spectrum, which clearly shows the periodic resonances with the asymmetric Fano-resonance line shape.

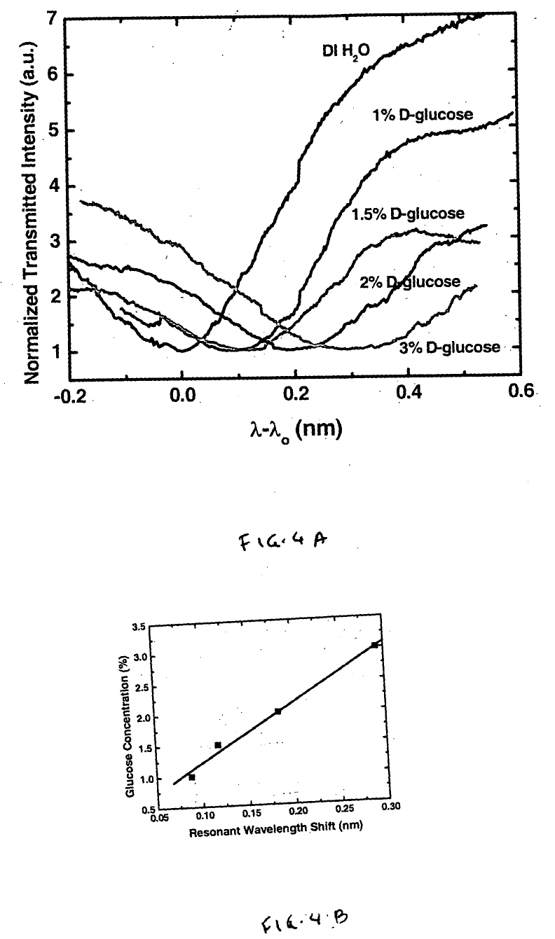

The microring resonator 50′ shown in FIG. 3A can be used, as a demonstrative example, to measure the concentration of glucose in water solutions. As discussed above, the resonant wavelengths depend on the effective refractive index of the waveguide mode that is affected by biomolecules attached to the surface of the waveguide or present in the surounding solution. In this demonstration the biochemical sensor 100 is immersed into a glucose solution. Hence, the change in the concentration of the solution affects both the effective index and the resonant wavelengths. The reference spectrum can be measured when the microring resonator 50′ is immersed in de-ionized water. FIG. 4A shows the spectra for different concentrations of glucose in water and FIG. 4B shows the concentration of glucose solution as a function of the wavelength shift of resonance. The shift in resonant wavelength and the variation of the normalized transmitted intensity is linearly related to the concentration of the glucose solution, as shown in FIG. 4B. The glucose concentration can also be measured by fixing the wavelength and monitor the transmitted light intensity. A significant change in the transmission can be obtained due to the increased slope in the Fano-resonances.

The polymer microring resonators 50, 50′ can also be used to detect chemicals in gas phase by choosing suitable material that can absorb the molecules sufficiently. Absorption of gas molecules changes the refractive index of the microring waveguide 54, and causes a detectable shift in the transmission spectra or a change of transmission intensity at a fixed wavelength.

Referring to FIG. 5A, a vertically-coupled microresonator 160 includes a polymer microdisk 151 that is formed on top of a pre-defined optical bus waveguides 152 for vertical coupling of energy therebetween. A pedestal structure 158 made of a thin oxide layer, such as SiO₂ can be used to provide vertical separation. The thickness of the pedestal structure 158 can be controlled with great precision by the fabrication process. Referring to FIG. 5B, another vertically coupled microresonator 170 includes a polymer microring 174 that is formed on top of pre-defined optical bus waveguides 172 for vertical coupling of energy therebetween. In the vertically coupled structures shown in FIGS. 5A and 5B, the cores of the bus waveguides 152, 172 can be cladded with fluids, such as water, air, or organic solvent, and can also be cladded with other dielectric materials, such as polymers.

The sensitivity of the various microresonators 50, 50′ used in the biochemical sensor 100 can be increased by incorporating an optical gain mechanism into the corresponding microring waveguides 54. The gain mechanism can be achieved by, but not limited to, doping the polymer microring waveguide 54 with gain media such as fluorescent dyes, or by assembling dye molecules onto the waveguide surfaces. The sensitivity improvement for detection of biomolecules or chemical analytes is illustrated in FIG. 6, which shows the transmission coefficient as a function of gain/loss factor. As can be seen from FIG. 6, at resonance, a slight change in gain/absorption (or in the phase shift) can cause a big change in the transmitted power.

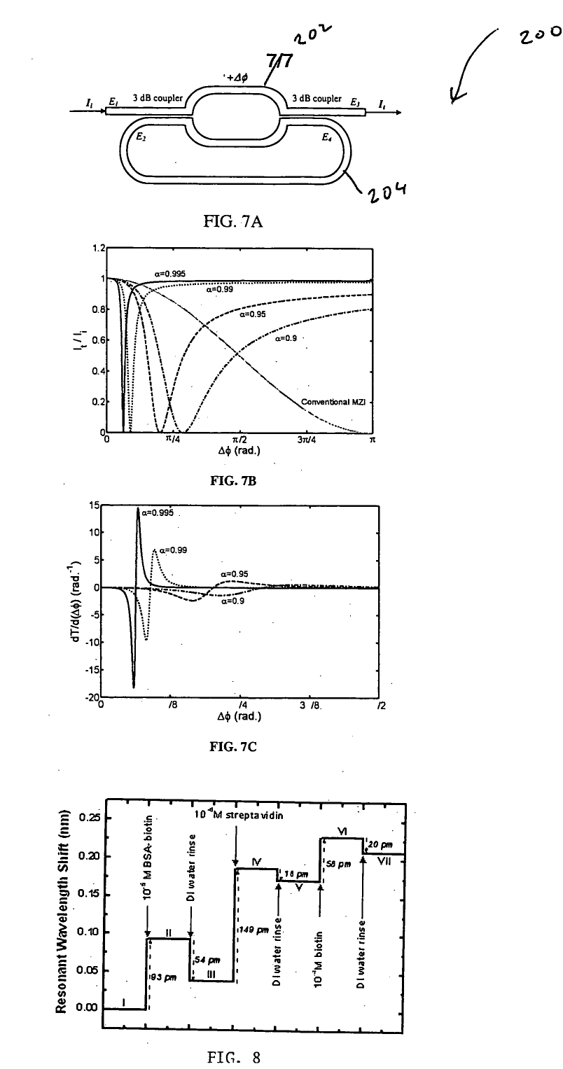

Referring to FIG. 7A, in another aspect of the present teachings, a ring feedback Mach-Zehnder interferometric (RF-MZI) sensor 200 for biosensor applications is provided. The RF-MZI sensor 200 can also be polymeric coated or made entirely from polymer and fabricated using the direct imprinting technique, as discussed above. The RF-MZI sensor 200 includes a first arm 202 which is open, and a second arm 204, which defines a ring feedback loop, in contrast to the conventional MZI devices, which include two open arms. The effect of the measurand molecules causes a measurable relative phase shift Δφ between the open arm 202, and a corresponding portion of the ring feedback arm 204. In the RF-MZI sensor 200, the output E₄ from the 3dB coupler at the output side is fed back to the 3dB coupler at the input side. When the phase of this feedback loop is equal to a multiple integer of 2π, the overall transmission characteristics of the sensor 200 changes drastically, as illustrated in FIGS. 7B and 7C. The curves in FIG. 7B correspond to the modulated transmission of the RF-MZI sensor 200 for different amounts of optical field attenuation in the feedback loop (α=1 represents zero attenuation). As a comparison, the transmission of a conventional MZI is also shown in FIG. 7B. Enhancement in sensitivity is illustrated in FIG. 7C, which shows the slope of the modulated transmission as a function of the phase shift. A nearly 100 fold increase in the slope sensitivity can be achieved in the RF-MZI sensor 200 as compared with a conventional MZI. The RF-MZI sensor 200 can be used with optical fiber or planar waveguides.

Referring to FIG. 8, in some aspects of the present teachings as discussed herein, the surface of at least a portion of the resonator 50 can be provided with one or more receptors for binding with biomolecules to permit surface sensing. In some embodiments, surface sensing requires bonding sites on the sensor surfaces. To demonstrate such properties, streptavidin-biotin was chosen, wherein biotin (molecular weight M_{w}=244 Da, also known as vitamin H) is a small biomolecule and streptavidin (M_{w}=66 000˜75 000 Da) is a type of protein consisting of 512 amino acids, which is a relatively large biomolecule. One streptavidin molecule has four binding sites to biotin, and this system has a very high affinity and adsorption coefficient (Kₐ˜10¹⁵M⁻¹).

In this demonstration, a polystyrene microring resonator was subjected to DI water, biotinylated bovine serum albumin (biotin-BSA), streptavidin, and biotin solutions of various concentrations, and the device was rinsed with DI water after each step. FIG. 8 illustrates the evolution of the resonant wavelength shift measured during these steps. Initially, the microring resonator was measured with DI water as the reference. In the first step, the device was incubated in a biotin-BSA solution of 10⁻⁵ M concentration, and a resonant shift of 93 pm was observed. This shift is due to both the ready adsorption of biotin-BSA molecules on the waveguide surface and the free biotin-BSA molecules in the solution surrounding the microring. The device was subsequently rinsed in DI water to remove nonadsorbed biotin-BSA in the solution, and the resonance moved back by 54 pm. The net shift of 39 pm was due to the biotin-BSA adsorbed on the microring surfaces. The adsorbed biotin-BSA molecules provide biotin functionality on the sensor surfaces as binding sites. In addition, BSA is able to repel nonspecific adsorption of other proteins, which enhances the device's specificity. With information about the molecular weight (M_{w}=66 432 Da) and size (4 nm×4 nm×14 nm) of BSA, there are sufficient biotin-BSA molecules forming a monolayer on the sample surface.

In the second step, drops of streptavidin solution (10 μL) with a concentration of 10⁻⁶ M were introduced to the device surface, and a shift of 149 pm was recorded. Due to the high affinity between streptavidin and biotin, streptavidin tends to bind only to biotin on the sensor surfaces. Based on the size of the streptavidin molecules, 5.6 nm×4.2 nm×4.2 nm, it was determined that about ˜2×10⁻¹² mol of streptavidin molecules from the solution formed a monolayer on the sensor chip, which means that there were still free streptavidin molecules in the surrounding solution. Again, the device was rinsed in DI water to remove nonadsorbed streptavidin, leading to a reverse shift of 16 pm. In this step, the net shift of 133 pm is the result of the binding of streptavidin molecules to the biotinylated BSA on the microring.

Typically, only parts of the four biotin binding sites per streptavidin are bound to biotin-BSA, while still leaving some available biotin binding sites. In the last step, a biotin solution with a concentration of 10⁻⁴ M was introduced, which caused a resonant redshift of 58 pm. After a DI water rinse, the resonance shifted back by 20 pm. This indicates that some biotin molecules were bound to the free binding sites on the streptavidin molecules. Therefore, the net shift of 38 pm implies the binding of biotin molecules to the streptavidin on the microring surface.

This demonstration not only demonstrated surface sensing of bound biomolecules, but also illustrates that such polymer microring resonators are capable of detecting both small molecules (such as biotin) and large biomolecules (such as proteins) without using fluorescent labels. The use of biotin-streptavidin pair can be generally applied to a large number of protein molecules by, e.g., first creating biotin functionality on the waveguide surface and then binding streptavidin, which provides biotin binding sites that can further bind any biotinylated protein molecules.

Based on these results, the detection limit, defined as the smallest detectable mass coverage per unit surface area, can be calculated. Assuming that a microring resonator has a Q factor of 20 000 and the resolvable wavelength shift is one-tenth of the resonant bandwidth, the detection limit is ˜250 pg/mm² in the case of streptavidin molecules. IN comparison with commercial quartz crystal microbalance (QCM) biosensors, this preliminary result is comparable to that of QCM, typically in the range of 50˜100 pg/mm². As for SPR biosensors, they can reach a detection limit as low as a few picograms per square millimeter^{p}. However, with enhancement of the Q factor, employment of a three-dimensional (3-D) matrix to create more molecular binding sites, and control of temperature, we believe that the detection limit of microring devices can be further reduced. Moreover, microring sensors have a unique advantage of array capability. With simple and highly robust fabrication technology, a large array of microring sensors can be integrated on a same chip. With suitable molecular functionality on each microring, and the ease of controlling the resonance wavelength by choosing different ring sizes, the sensor chip can be used to detect various analytes simultaneously. This high integration capability strongly contrasts that of SPR sensors because the latter rely largely on free space optical elements for detection.

The biochemical sensors of the present teachings achieve enhanced sensitivity with low fabrication costs. For example, the use of polymers or polymeric coatings provides rich surface functionality for binding biomolecules, low surface roughness scattering, and high fiber coupling efficiency. The polymeric biochemical sensors can be fabricated using the direct imprinting method, which provides direct integration with electronic and photonic components, as well as high throughput and low fabrication costs. Active gain media or nonlinear optical properties can be incorporated in the polymer components to achieve a narrowed resonance for enhanced sensitivity. Further, using a microring structure provides a single-mode operation, which is very efficient and economical in the use of analyte solution. Additionally, the present teachings provide ring feedback enhancement for MZI sensors.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A biochemical sensor comprising:
a microcavity resonator comprising a sensing element defining a closed loop waveguide, and wherein the biochemical sensor is operable to detect a measurand by measuring a resonance shift in the microcavity resonator.

2. The biochemical sensor of claim 1, wherein the sensing element is a microring waveguide having a coating comprising organic material, and wherein the microcavity resonator further comprises:
at least one bus waveguide operable as input and output; and
a fluid cladding.

3. The biochemical sensor of claim 2, wherein the organic material comprises polymer and the fluid is selected from the group consisting of air, water, and organic solvent.

4. The biochemical sensor of claim 2, wherein the microring waveguide is made entirely of material comprising polymer.

5. The biochemical sensor of claim 2, wherein the bus waveguide further includes a pair of partially reflecting elements.

6. The biochemical sensor of claim 5, wherein the partially reflecting elements are waveguide offsets.

7. The biochemical sensor of claim 1, wherein the sensing element comprises gain media.

8. The biochemical sensor of claim 1, wherein the sensing element comprises a single-mode propagation waveguide.

9. The biochemical sensor of claim 2, wherein the microring waveguide is vertically coupled with the bus waveguides.

10. The biochemical sensor of claim 2, wherein the sensing element is a microring waveguide having at least one receptor for binding biomolecules.

11. An inteferometric biochemical sensor comprising:
an open arm; and
a ring feedback arm coupled to the open arm, the biochemical sensor operable to amplify a phase shift between the open arm and a corresponding portion of the ring feedback arm in the presence of a measurand.

12. The interferometric biochemical sensor of claim 11, wherein the open arm and the ring feedback arm comprise organic material.

13. The interferometric biochemical sensor of claim 11, wherein the ring feedback arm comprises active gain media.

14. The interferometric biochemical sensor of claim 12, wherein the organic material comprises polymer.

15. The interferometric biochemical sensor of claim 11, wherein the open arm and the ring feedback arm comprise at least one receptor for binding biomolecules.

16. A biochemical sensor comprising:
a microcavity resonator having an asymmetric resonance line shape, wherein the biochemical sensor is operable to detect a measurand by measuring a resonance wavelength shift in the microcavity resonator.

17. The biochemical sensor of claim 16, wherein the microcavity resonator comprises a microring waveguide, and at least one bus waveguide having a pair of partially reflecting elements.

18. The biochemical sensor of claim 17, wherein the pair of partially reflecting elements comprise offsets in the bus waveguide.

19. The biochemical sensor of claim 17, wherein the microring waveguide comprises organic material.

20. The biochemical sensor of claim 19, wherein the microring comprises gain media.

21. The biochemical sensor of claim 17, wherein the organic material comprises polymer.

22. The biochemical sensor of claim 17, wherein the microring waveguide is vertically coupled to the bus waveguide.

23. The biochemical sensor of claim 17, wherein the microring waveguide comprises at least one receptor for binding biomolecules.
